(19) United States
(12) Patent Application Publication
(10) Pub. No.: US 2008/0100029 A1
(43) Pub. Date: May 1, 2008

(54) One-piece frame for a bicycle

(75) Inventor: Samuel Hu, Changhua City (TW)

Correspondence Address: Thomas E. Sisson;Jackson Walker, LLP, Suite 2400, 112 E. Pecan, San Antonio, TX, 78205, US

(73) Assignee: Astro Engineering Co., Ltd.

(21) Appl. No.: 11/586,973

(22) Filed: Oct. 26, 2006

(51) Int. Cl. B62K 7/00

(52) U.S. Cl. 280/281.1

(57) ABSTRACT

A one-piece frame for a bicycle has more than two hollow metal tubes connecting to each other by welding to form an initial frame. The initial frame is put into a mold. With the hydraulic pressure process, the metal tubes and the welding parts between the metal tubes are expanded to form the one-piece frame. Therefore, the strength of the one-piece frame is enhanced. Furthermore, multiple protruding patterns are formed on an outside surface of the one-piece frame to enhance the strength and aesthetics.

### BACKGROUND OF THE INVENTION

1. Field of the Invention

The present invention relates to a one-piece frame for a bicycle, and more particularly to the one-piece frame that has various appearances to attract customers.

2. Description of the Related Art

At present and in the market of bicycles, manufacturers pay more attention to strong frame, lightweight and aesthetic appearance of the bicycle to enhance the quality and to attract consumers. A first conventional bicycle comprises multiple hollow metal pipes respectively connected with each other. However, the first conventional bicycle is heavy and inconvenient to assemble. Furthermore, jointing parts between the pipes are easy to be damaged.

A second conventional bicycle has a one-piece frame. The one-piece frame is formed by multiple pipes that are directly expanded via hydraulic pressure. However, with the immature technology of hydraulic pressure, a head tube of the one-piece frame is not smooth such that the head tube needs to be cut and welt thereby increasing more processing procedures. Furthermore, the second conventional bicycle shows nothing aesthetics.

Therefore, the invention provides a one-piece frame for a bicycle to mitigate or obviate the aforementioned problems.

### SUMMARY OF THE INVENTION

The main objective of the present invention is to provide a one-piece frame for a bicycle, and more particularly to the one-piece frame that has various appearances to attract customers.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first preferred embodiment of a one-piece frame for a bicycle in accordance with the present invention;

FIG. 2 is operational views of material for the one-piece frame for a bicycle in FIG. 1;

FIG. 3 is an operational side view in partial section of a mold and material for the one-piece frame for a bicycle in FIG. 1;

FIG. 4 is a side view of an initial frame of the one-piece frame for a bicycle in FIG. 1;

FIG. 5 is a side view of a second preferred embodiment of a one-piece frame for a bicycle in accordance with the present invention;

FIG. 6 is operational views in partial section of a mold and material for the one-piece frame for a bicycle in FIG. 5;

FIG. 7 is a side view of a third preferred embodiment of a one-piece frame for a bicycle in accordance with the present invention; and

FIG. 8 is operational views in partial section of a mold and material for the one-piece frame for a bicycle in FIG. 7;

### DETAILED DESCRIPTION OF THE PREFERRED EMBODIMENT

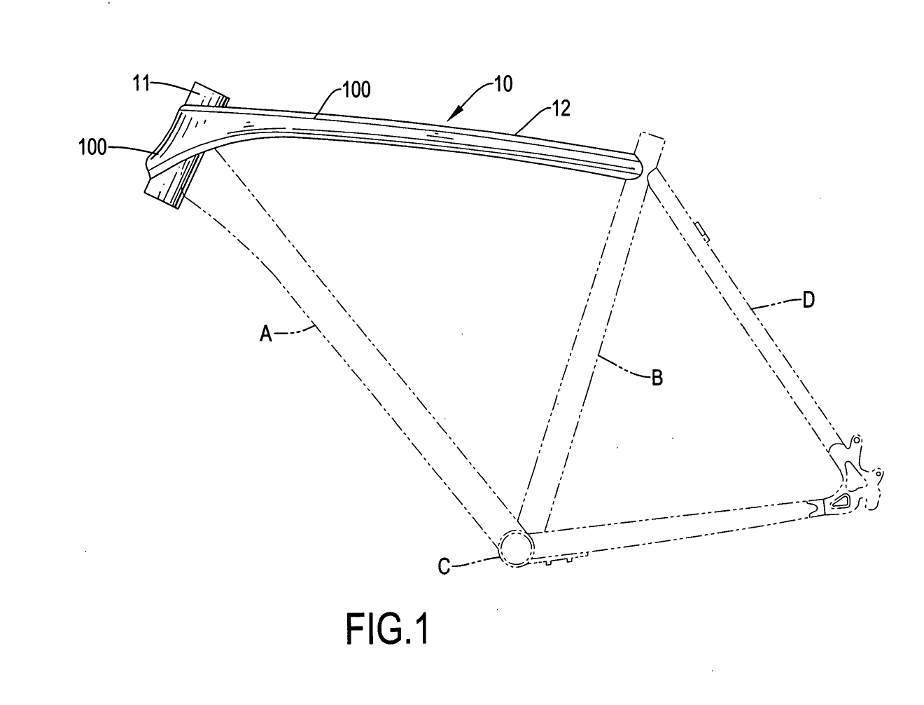

With reference to FIG. 1, a first embodiment of a one-piece frame (10) of a bicycle in accordance with the present invention comprises a hollow head tube (11) and a hollow upper tube (12). The head tube (11) and the upper tube (12) connect to a lower tube (A), a seat tube (B), a linking tube (C) and a rear fork (D) to form a complete bicycle frame. A front end of the upper tube (12) connects to the head tube (11) by welding. The upper tube (12) communicates with the head tube (11). With the hydraulic pressure forming process and a mold, the head tube (11) and the upper tube (12) are expanded to form the one-piece frame (10) with a continuous outside surface. The one-piece frame (10) may have multiple protruding patterns (100) formed on the outside surface of the one-piece frame (10) to enhance the strength and aesthetics.

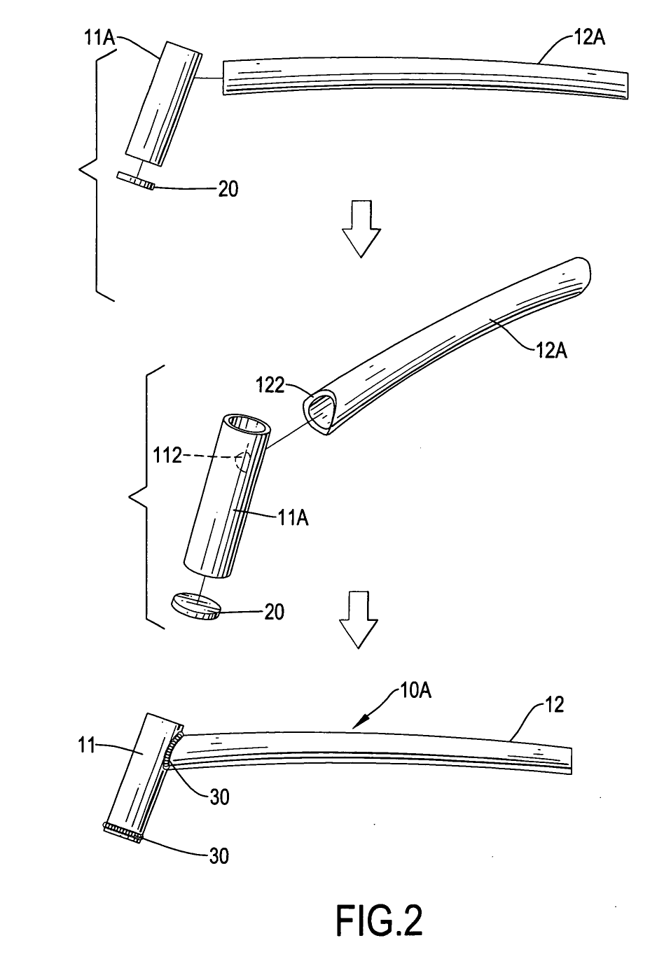

With further reference to FIG. 2, an initial frame (10A) of the one-piece frame as described comprises a first metal tube (11A), a second metal tube (12A) and a cover (20). The first metal tube (11A) has a through hole (112). A recess (122) is formed in a front end of the second metal tube (12A). The recess (122) of the second metal tube (12A) is welded in the through hole (112) in the first metal tube (11A). The cover (20) is attached to and seals one end of the first metal tube (11A).

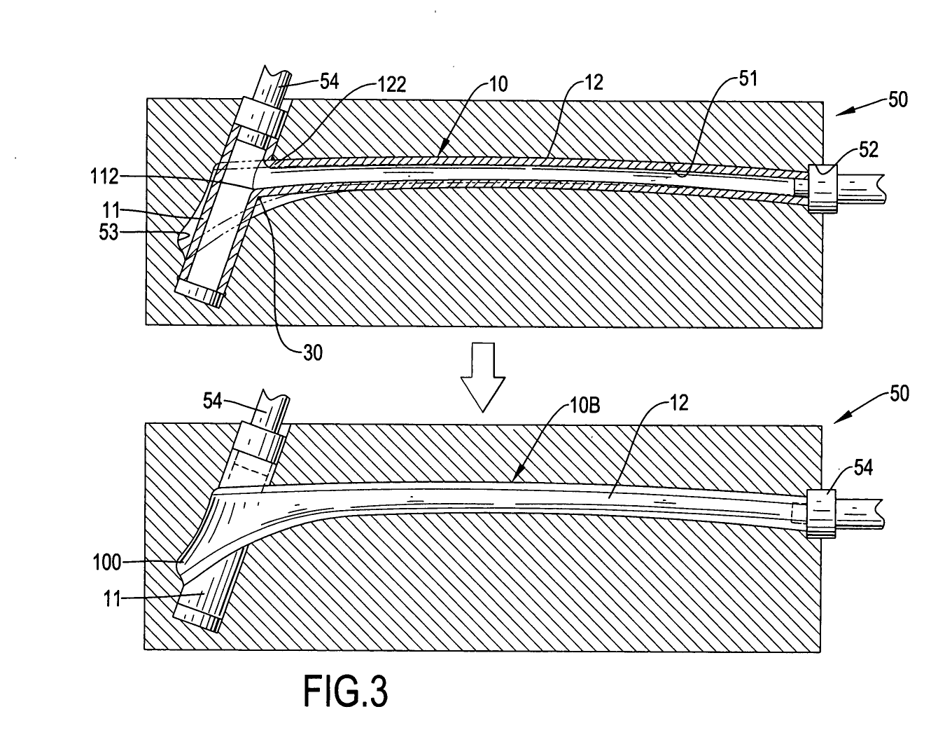

With further reference to FIG. 3, the initial frame (10A) is formed to be the one-piece frame as described by hydraulic pressure with a mold (50). The mold (50) has a cavity (51), two openings (52) and multiple pattern recesses (53). The cavity (51) of the mold (50) corresponds to the one-piece frame (10). The openings (52) communicate with the cavity (51). The pattern recesses (53) communicate with the cavity (51) and correspond to the protruding patterns (100) on the one-piece frame (10). The initial frame (10A) is put into the cavity (51) of the mold (50). Two opening ends of the initial frame (10A) respectively align with the openings (52) of the mold (50). Two hydraulic devices (54) are inserted into the openings (52) to inject the high pressure liquid into the initial frame (10A). Cooperating with appropriate heating to enhance the ductility of the initial frame (10A), the initial frame (10A) is expanded and the outside surface of the initial frame (10A) contacts with the inside wall of the cavity (51) and the pattern recesses (53) in the mold (50). The welding part (30) between the metal tubes (11A, 12A) of the initial frame (10A) is also expanded to enhance the connecting strength and to become homogeneous.

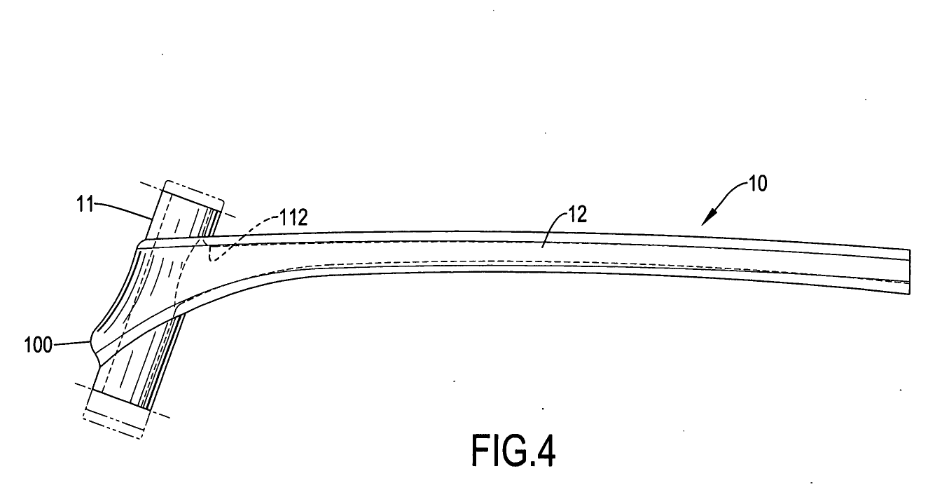

With further reference to FIG. 4, with the mold (50) being removed and the cover (20) and the unnecessary parts being also removed, the one-piece frame (10) is finished.

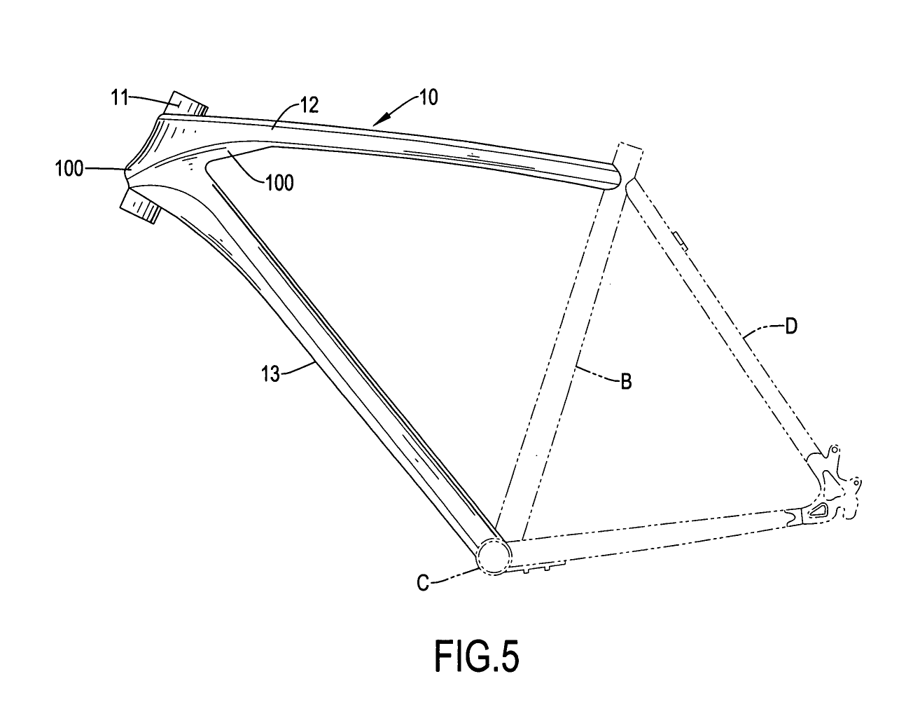

With further reference to FIG. 5, a second embodiment of a one-piece frame (10) of a bicycle in accordance with the present invention comprises a hollow head tube (11), a hollow upper tube (12) and a hollow lower tube (13). The head tube (11), the upper tube (12) and the lower tube (13) connect to a seat tube (B), a linking tube (C) and a rear fork (D) to form a complete bicycle frame. A front end of the upper tube (12) and a front end of the lower tube (13) respectively connect to the head tube (11) by welding. The upper tube (12) and the lower tube (13) communicate with the head tube (11). With the hydraulic pressure forming process and a mold, the head tube (11), the upper tube (12) and the lower tube (13) are expanded to form the one-piece frame (10) with a continuous outside surface. The one-piece frame (10) may have multiple protruding patterns (100) formed on the outside surface of the one-piece frame (10) to enhance the strength and aesthetics.

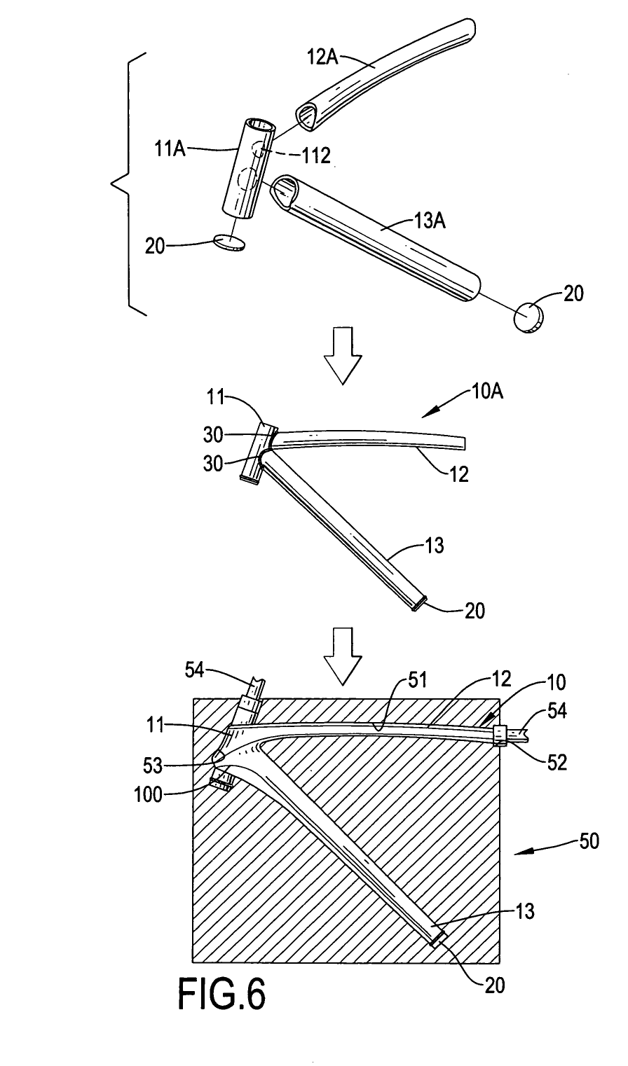

With further reference to FIG. 6, an initial frame (10A) of the one-piece frame as described comprises a first metal tube (11A), a second metal tube (12A), a third metal tube (13A) and two covers (20). The first metal tube (11A) has two through holes (112). The second and third metal tube (12A, 13A) is welded in the through holes (112) in the first metal tube (11A). The covers (20) are attached to and seals the first metal tube (11A) and the third metal tube (13A).

The initial frame (10A) is formed to be the one-piece frame as described by hydraulic pressure with the mold (50). The initial frame (10A) is expanded and the outside surface of the initial frame (10A) contacts with the inside wall of the cavity (51) and the pattern recesses (53) in the mold (50). With the mold (50), the cover (20) and the unnecessary parts being removed, the one-piece frame (10) is finished.

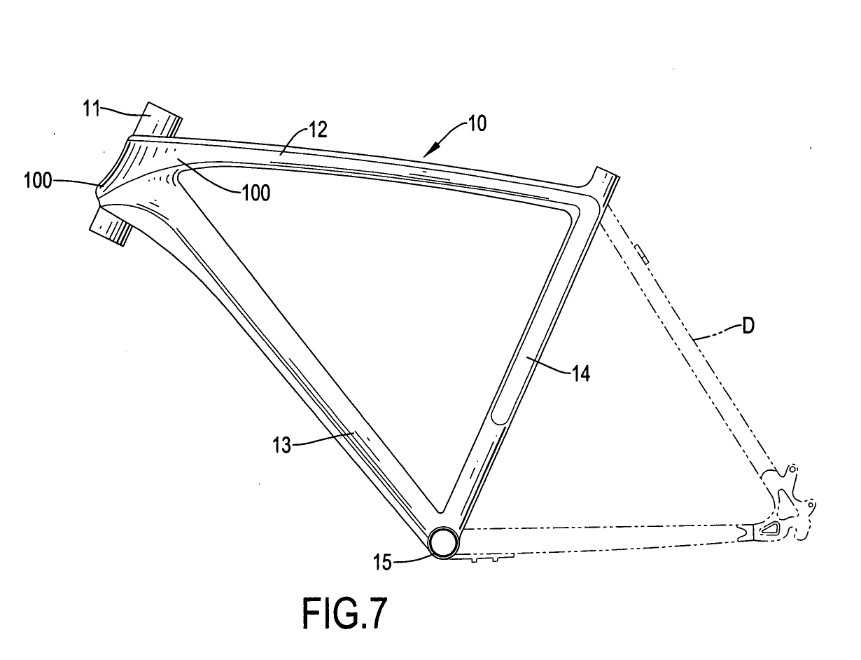

With further reference to FIG. 7, a third embodiment of a one-piece frame (10) of a bicycle in accordance with the present invention comprises a hollow head tube (11), a hollow upper tube (12), a hollow lower tube (13), a seat tube (14) and a linking tube (15). The head tube (11), the upper tube (12), the lower tube (13), the seat tube (14) and the linking tube (15) connect to a rear fork (D) to form a complete bicycle frame. A front end of the upper tube (12) and a front end of the lower tube (13) respectively connect to the head tube (11) by welding. A rear end of the upper tube (12) connects to the seat tube (14) by welding near a top end of the seat tube (14). A bottom end of the seat tube (14) and a rear end of the lower tube (13) connect to the linking tube (15) by welding. The tubes (11,12, 13, 14, 15) communicate with each other. With the hydraulic pressure forming process and a mold, the tubes (11,12, 13, 14, 15) are expanded to form the one-piece frame (10) with a continuous outside surface. The one-piece frame (10) may have multiple protruding patterns (100) formed on the outside surface of the one-piece frame (10) to enhance the strength and aesthetics.

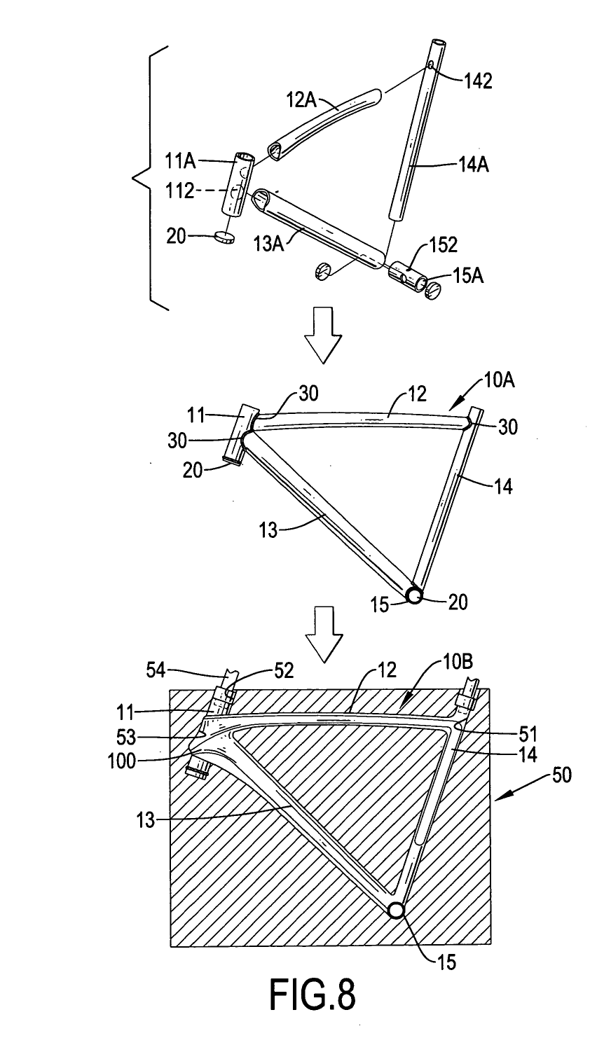

With further reference to FIG. 8, an initial frame (10A) of the one-piece frame as described comprises a first metal tube (11A), a second metal tube (12A), a third metal tube (13A), a fourth metal tube (14A), a fifth metal tube (15A) and three covers (20). The first metal tube (11A) and the fifth metal tube (15A) respectively have two through holes (112, 152). The fourth metal tube (14A) has a through hole (142). The second and third metal tube (12A, 13A) is welded in the through holes (112) in the first metal tube (11A). The third and fourth metal tubes (13A, 14A) are welded in the through holes (152) in the fifth metal tube (15A). The second metal tube (12A) is welded in the through hole (142) in the fourth metal tube (14A). The covers (20) are attached to and seals the first and fifth metal tubes (11A, 15A).

The initial frame (10A) is formed to be the one-piece frame as described by hydraulic pressure with the mold (50). The initial frame (10A) is expanded and the outside surface of the initial frame (10A) contacts with the inside wall of the cavity (51) and the pattern recesses (53) in the mold (50). After the mold (50) is removed and the cover (20) and the unnecessary parts are also removed, the one-piece frame (10) is finished.

The advantages of the present invention are described as follows:

1. With one-piece technology, the present invention has a strong structure and a lightweight.

2. With hydraulic pressure method, the present invention is formed more precisely and has a quick processing procedure and a lower cost.

### 3. With the protruding patterns (14), the present invention has various appearances to attract customers.

4. With the hydraulic pressure process, the welding parts between the tubes are expanded to enhance the connecting strength and to become homogeneous.

It is to be understood, however, that even though numerous characteristics and advantages of the present invention have been set forth in the foregoing description, together with details of the structure and function of the invention, the disclosure is illustrative only. Changes may be made in details, especially in matters of shape, size, and arrangement of parts within the principles of the invention to the full extent indicated by the broad general meaning of the terms in which the appended claims are expressed.

What is claimed is:

1. A one-piece frame for a bicycle comprising:
a hollow head tube;
at least one hollow tube connecting to the head tube by welding, and each one of the at least one hollow tube has a welding part connecting to the head tube wherein the head tube, the at least one tube and the welding parts are expanded by hydraulic pressure to form continuous outside surfaces; and
at least one protruding pattern formed on an outside surface of the one-piece frame.

2. The one-piece frame for a bicycle as claimed in claim 1, wherein the head tube and the at least one tube communicate with each other.

3. The one-piece frame for a bicycle as claimed in claim 1, wherein the at least one tube comprises an upper tube having a front end connecting to the head tube.

4. The one-piece frame for a bicycle as claimed in claim 1, wherein the at least one tube comprises a lower tube having a front end connecting to the head tube.

5. The one-piece frame for a bicycle as claimed in claim 1, wherein the at least one tube comprises an upper tube and a lower tube respectively having a front end connecting to the head tube.

6. The one-piece frame for a bicycle as claimed in claim 1, wherein
the at least one tube comprises an upper tube and a lower tube respectively having a front end connecting to the head tube;
a seat tube connects to a rear end of the upper tube; and
a linking tube respectively connects to a rear end of the lower tube and a bottom end of the seat tube.
